(19) United States
(12) Patent Application Publication
(10) Pub. No.: US 2022/0129529 A1
(43) Pub. Date: Apr. 28, 2022

(54) BIOMETRIC-VALIDATED CHARACTER PASSWORD AUTHENTICATION PROCEDURE

(71) Applicants: Peter Garrett, Mill Valley, CA (US); Paul Regen, Felton, CA (US)

(72) Inventors: Peter Garrett, Mill Valley, CA (US); Paul Regen, Felton, CA (US)

(21) Appl. No.: 17/083,108

(22) Filed: Oct. 28, 2020

(51) Int. Cl. G06F 21/32; G06F 21/46; G06F 21/44; G06F 21/57

(52) U.S. Cl. CPC G06F 21/32; G06F 21/575; G06F 21/44; G06F 21/46

(57) ABSTRACT

A computing device for generating and communicating a linear security code sequence, individual ones or combinations of the generated security code sequence associated with at least one device-generated bio signature from a user operating the device, the device comprising a computer housing, a power source, a micro controller, a boot device, a memory device, a wireless communications chip or modem, an electronic display, and a data entry interface.

### CROSS-REFERENCE TO RELATED DOCUMENTS

N/A

### BACKGROUND OF THE INVENTION

### 1. Field of the Invention

The present invention is in the field of biometric security systems and pertains particularly to a method for assigning biometrics such as fingerprints to one or more characters contained within a password used to authenticate a user over a network or to gain entrance to a secure space.

### 2. Discussion of the State of the Art

Recently, there has been tremendous growth in the fields of data protection and security for computing devices connected to a network. Biometrics have been incorporated into authentication procedures realizing a need for heightened data security and privacy for users Biometric fingerprint identification systems are inherently more secure than simple character passwords and other commonly used identification methods known in the art. As a result, many computer and cell phone manufacturers have incorporated fingerprint readers into their hardware enabling users to scan in a biometric like a fingerprint to use as authentication data on a network or to open or unlock a folder or memory device.

One issue with biometric fingerprint authentication is that it is common for any fingerprint readers leave a user's fingerprint on the fingerprint reader surface. A hacker who is sophisticated may be able to lift, duplicate, and then use a scanned fingerprint of a user to circumvent the fingerprint reader and falsely represent the user online and in other scenarios. It occurred to the inventors that a new layer of security is needed that may include biometric validation of specific user submitted data.

Therefore, what is clearly needed is an authentication procedure for consumer protection that combines biometric validation of unique password characters.

### BRIEF SUMMARY OF THE INVENTION

According to embodiments of the present invention, a computing device for generating and communicating a linear security code sequence is provided wherein individual ones or combinations of the generated security code sequence is associated with at least one device-generated bio signature from a user operating the device, the device incudes a computer housing, a power source, a micro controller, a boot device, a memory device, a wireless communications chip or modem, an electronic display, and a data entry interface.

In one embodiment of the invention, the linear security code sequence generated contains one or a combination of alphanumeric characters and or symbols. In one embodiment, the at least one bio signature of a user operating the device includes at least one fingerprint or thumb print or a combination thereof. In a variation of this embodiment, the bio signature is generated by a fingerprint scanning application and a scan window appearing in the electronic display, the application executable from device memory by an operating system (OS).

In one embodiment, the power source is a rechargeable battery. In one embodiment, the data entry interface is a touch screen feature in the electronic display. In one embodiment, the wireless chip is a Bluetooth chip enabling communications between the computing device and another Bluetooth system, device, or node. In another embodiment, the wireless modem enables the computing device to connect to an Internet network resource.

In one embodiment, access to the OS on the computing device requires entry and authentication of a linear security code generated on the device and scan and authentication of the at least one fingerprint and or thumbprint associated to the individual ones or combinations of the linear security code characters. In one embodiment wherein the bio-metric is a fingerprint or thumbprint, each generated character of the generated linear security code is associated to a unique fingerprint or thumbprint.

In one embodiment, the computing device is integrated into an automobile computer system. In another embodiment, the computing device is integrated into a door lock having a default state of being locked. In one embodiment wherein the biometric is a finger or thumbprint, the fingerprint scan window is supported by hardware adapted to scan images, codes, and fingerprints and or thumbprints.

According to another aspect of the invention, a method for electronic generation of a linear security code is provided wherein individual ones or combinations of the code characters are associated to at least one or a combination of finger and or thumbprints using a computing device, the computing device including a computer housing, a power source, a micro controller, a boot device, a memory device, a wireless communications chip or modem, an electronic display, and a data entry interface, the method including steps (a) booting the computing device to a run state, (b) on the computing device, displaying a bio-pass code data entry field and highlighting a fingerprint scan window in the display (c) on the computing device, entering a one or more characters, numbers, or symbols, or a combination thereof via the data entry interface into the bio-pass code data entry field, (d) on the computing device, scanning in a fingerprint or a thumbprint via the scan window of (b), (e) on the computing device, associating the finger or thumbprint of (d) to the character, number, or symbol, or combination thereof entered in (c), (f) repeating steps (c), (d), and (e) until a required or desired number of characters, numbers, or symbols and fingerprints, thumbprints, or a combination thereof are entered.

In one aspect of the method, the scan window is part of a bio-signature scanning application executable from the memory on the device. In one aspect of the method, in (a) a bio-pass code must be entered and authenticated before the device can be booted to a run state. In one aspect, in (c) the data entry interface is a physical keyboard or keypad. In another aspect of the method, in (c) the data entry interface is a digital keyboard or keypad and is part of the display.

In one aspect of the method, in (e) the association is made automatically in the background. In one aspect of the method, in (f) the bio-pass code is created for the first time or the bio-pass code is being used to authenticate a user to gain access to one of a physical space, a virtual space, or a data resource, or to authenticate the user in a transaction.

### BRIEF DESCRIPTION OF THE SEVERAL VIEWS OF THE DRAWINGS

FIG. 1A is an elevation view of a biometric fingerprint security device according to an embodiment of the present invention.

FIG. 1B is a block diagram depicting electronic components of the security device of FIG. 1A.

FIG. 2 is a process flow chart depicting steps for creating a bio-pass code using the security device of FIG. 1A.

FIG. 3 is a process flow chart depicting steps for authenticating a bio-pass code created on the security device of FIG. 1A.

FIG. 4A is a screen shot of the security screen of FIG. 1A prompting a user to enter a bio-pass code to unlock the security device of FIG. 1A from a sleep mode.

FIG. 4B is a screen shot of the security screen of FIG. 1A displaying symbol character sheets as a resource for selecting characters for a bio-pass code.

FIG. 5 is a screen shot of the security screen of FIG. 1A of the security device of FIG. 1A integrated with an automobile computer system according to an embodiment of the present invention.

FIG. 6 is a screen shot of the security screen of FIG. 1A of the security device of FIG. 1A integrated into a computerized door lock system according to an embodiment of the present invention.

### DETAILED DESCRIPTION OF THE INVENTION

In various embodiments described in enabling detail herein, the inventor provides a unique system for protecting a consumer's data and information and access authority to secure spaces. It is a goal of the invention to enhance user-derived pass code, personal identification number (PIN), or password characters through biometric association to individual ones of the selected characters. The present invention is described using the following examples, which may describe more than one relevant embodiment falling within the scope of the invention.

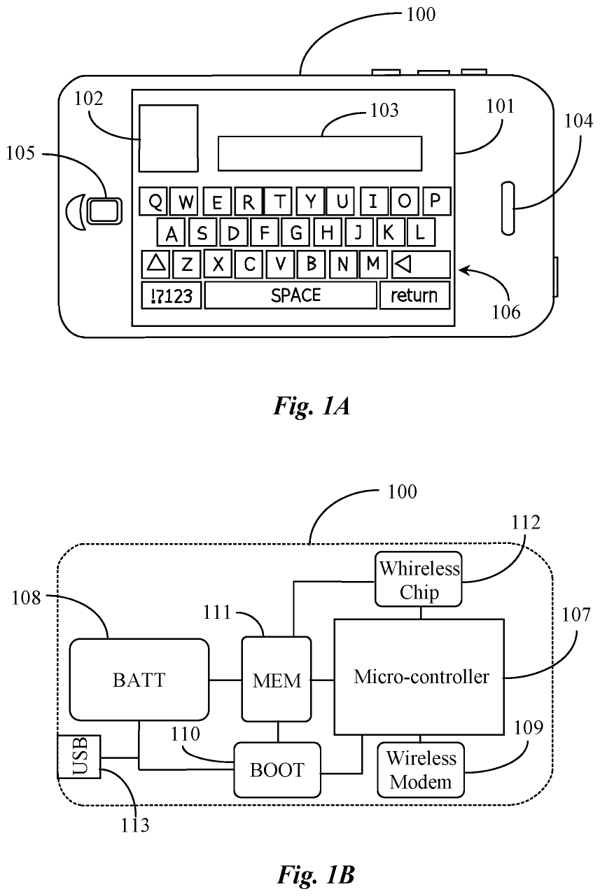

FIG. 1A is an elevation view of a biometric fingerprint security device 100 according to an embodiment of the present invention. Security device 100 is a computerized device adapted to enable users to create bio-pass codes to elevate security levels for entry into secured spaces like a room or a building, or a vault, or access to secured data, secured computing device operating systems, virtual spaces, or general authentication procedures practiced over a secured data network.

Security device 100 may be a dedicated device that includes a security display screen 101 and a keyboard style input device 106. Input device 106 may be a touch screen displayed device to enable a user to select characters in the process of creating a bio-pass code. A bio-pass code, for the purposes of this specification, is a password or pass code created by a user where all or individual ones of selected numbers, characters, or symbols making up a secure password or personal identification code are authenticated as being created by the user using a biometric from the user, in this embodiment, a finger or thumbprint.

Security device 100 includes a fingerprint scanning capability in this embodiment. Security screen 101 includes a fingerprint scanning window 102 adapted as a finger or thumb placement window for subsequent scanning into the device of the finger or thumb print of the user. Security screen 101 includes a character display field for displaying selected pass code characters as visible data or as encrypted data, the characters selected using input device 106 by a user when creating a bio-pass code.

In one embodiment, security device 100 is a computerized device that is dedicated for creating security bio-pass codes. In another embodiment, security device 100 may be incorporated on multiple task computing devices, for example, a smart phone having a display means and a character input means along with a capability of scanning in fingerprints. In this regard, there may be other components present such as a smart phone camera 105, a smart phone speaker element 104 and typical power and volume buttons and a charge port.

FIG. 1B is a block diagram depicting electronic components, some optional, of security device 100 of FIG. 1A. Security device 100 includes a micro-controller 107 powered by a rechargeable battery (BATT) 108. Security device 100 is a boot able device having a boot device or bios 110 connected to battery 108 and a persistent memory (MEM) device 111 for holding data and executable software. In this example, security device 100 includes a universal serial bus (USB) data port 113 that may be used for data transfer, updating, and device battery charging.

In this embodiment, security device 100 is enabled for wireless communications with another computing device by the provision of a wireless chip 112 enabling the security device for Bluetooth communications. In one embodiment, security device 100 is further enabled to access a data network by provision of a wireless network modem enabling the device to be used to access a network resource and display information in security screen 101 and to enable upload of created security bio-pass codes for network authentication purposes.

In very general use of security device 100, a user may in the process of creating a security pass code, enter selected characters and have individual ones of those selected characters authenticated with a scanned print of the user that authenticates the individual character it is associated with. When using the created bio-pass code, the user may rescan finger and thumb prints previously associated with the user's selected characters and have those characters authenticated as being entered in real time by the user.

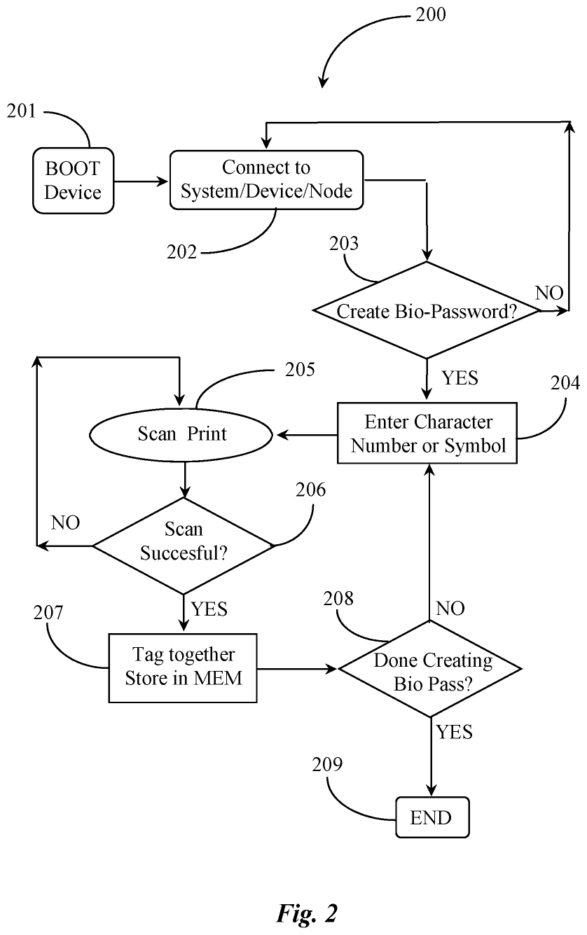

FIG. 2 is a process flow chart 200 depicting steps for creating a bio-pass code using the security device of FIG. 1A. At step 201, a user may boot up the security device from sleep mode or from a powered off state. Using wireless communications capability or wireless modem capability on the security device fully booted, the user may connect the device to a system, a device, or a network node. In this embodiment, the user is attempting to create a bio-pass code for use the next time the user is connected to the system, device, or node.

A system may be a machine, or a computing device, or an operating system, platform, or secured data on another device. A device may be the security device itself, a door lock, a safe lock, or some other security device having a capability of authenticating data passed to it. A node may be a server, a kiosk, or other network interface that the user may connect to over a network or make wireless communications contact with.

At step 203, the user may decide to create a bio-pass code. If the user decides against creating a bio-pass code to use at a system, device, or node, the process may loop back to step 202 until the user decides to create a bio-pass code. If at step 203, the user decides to create a bio-pass code the process may progress to step 204. It may be noted that the system, device, or node the user has connected to may prompt the user for a bio-pass code leading to step 204. At step 204, the user may enter a character, number, or symbol as a first character, number, or symbol of the bio-pass code. It may be noted herein that there may be typical restrictions on some characters, numbers, or symbols, or combinations thereof that may be accepted.

At step 205, the user may scan any finger or thumb print using the fingerprint scanner on the security device after the character, number or symbol has been selected. At step 206, the security device may confirm that the scan operation was successful. If the scan operation was not successful at step 205, the process may loop back to step 204 for another scan attempt. If at step 206, it is determined on the security device that the scan was successful then at step 207, the routine instruction or firmware running on the device may tag the scanned print or prints and the individual character or characters together where the scan authenticates that character or characters.

At step 208, the user may determine if they are finished creating a bio-pass code to use at a system, device, or node. It may be typical for the user to enter a series of characters, numbers, or symbols, or a combination thereof where the user chooses to associate scanned-in prints to individual ones of those selected characters. To associate a scanned print with a character for example, the user would enter the character and then scan the print. This might be done with every character, number, and symbol selected by the user in the code or the user may determine that two or more characters, numbers, and or symbols in the code might be authenticated with a scanned print. It is noted herein that a system, device, or node may require a minimum number of bio-characters, numbers, or symbols in the user's pass code.

If at step 208, the user is not finished creating the bio-pass code, then the process loops back for as many characters, numbers, and or symbols the system, device, or node requires for the stated level of security. If at step 208, the user is finished creating the bio-pass code, the process may end for that user at step 209. If the user is connected to the system, device, or node during the process, the data may be submitted as it is created and may be stored both locally and remotely.

If the user creates the bio-pass code while not connected to a system, device, or node where the code will be used to gain access or entry, then the user may connect and communicate wirelessly or otherwise submit the data in one session. In one embodiment, the user may enter the character A and then scan an index fingerprint on the left hand. Letter A in the pass code may be authenticated by the scanned print at the system, device, or node making it a requirement that another user stealing the user's pass word or attempting to guess it could not complete without being able to scan a fresh print. If the hacking entity has access to stored scans of the user, they would not work as they would have to be freshly scanned with a time stamp so the fresh print could be used to match the stored print authenticating at least one character or number or symbol used in an attempt to access.

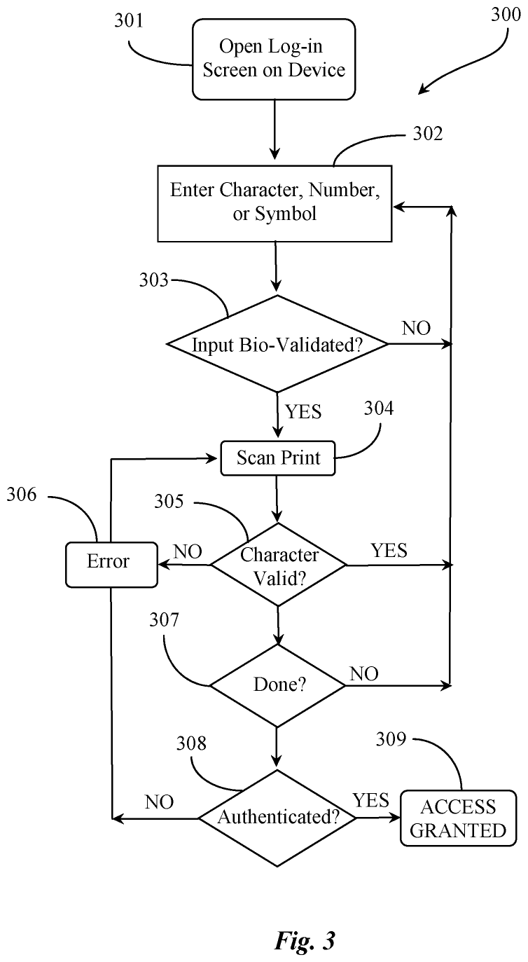

FIG. 3 is a process flow chart depicting steps 300 for authenticating a bio-pass code created on the security device of FIG. 1A. At step 301, the user may open a log-in screen on the security device. In one embodiment, a log-in screen is displayed as a result of connection and attempt to use the bio-pass code to gain entry or access to a system, device, or node. Typically, the screen will provide a field to enter the characters, numbers, and or symbols of the created bio-pass code. In one aspect, the user may not have to commit these characters to memory because they may be stored on the security device (retained after submission of the data).

At step 302, for example, a user may enter the first character, number, or symbol of the bio-pass code. At step 303, the system, device, or node may determine if the entered data of step 302 was bio-validated or has a scanned print in association with it. If at step 303, the first entered character, number, or symbol was not bio-validated, the process might resolve back to step 302 where the user may enter the next character (understanding that not all of the entered data is associated with a separate scan). If at step 303, the entered character is associated with a scanned print on file, then the process may move to step 304 where the user may scan in a fresh print of the correct finger or thumb print stored on the system, device or accessible to the node.

At step 305, the system, device, or network node may, in one aspect, determine if the fresh scanned print matches the stored print that validates the entered character. If at step 305, the print does not validate the character because it is a wrong print, the process might resolve to step 306 to inform the user of error and the process may loop back to scan print at step 304 for another try. If the system, device, or network node finds the freshly scanned print matches the print on file that validates the character entered, then the process may move back to step 302 for the next character, number, or symbol entry.

In one aspect, a user may commit a pass code to memory but not the authenticating finger and thumb prints. In such a case, to authenticate the prints, the system, device, or network node may prompt the user which prints to scan in after which characters are entered. In one aspect, the device, system, or network node may take all of the pass-code characters, numbers and or symbols of the bio-pass code and then prompt the user on which fingers and or thumbs to scan in to authenticate the individual characters, numbers, or symbols in the bio-pass code that are authenticated by the bio-signatures. In this way, the security device may “remember” the code and the user may then finish authentication by then scanning the individual fingers and thumb prints as prompted. The user is authenticated when the freshly scanned bio-signatures match the signatures already on file. It is noted herein that any key such as enter may be used to signify that the user is finished entering data.

At step 307, the user may determine whether they are done entering the characters, numbers, and or symbols and scanned all of the required prints. It may be noted that the entered data and bio-signatures are submitted to the system, device, or network resource the user is attempting to gain entry or access to. An example use case might be if a user is attempting to enter and open up a place of work where the user is the first employee on site in the morning. No other user having stolen the user's security device would be able to access the building without the freshly scanned fingerprints and or thumb prints. If the user is not done at step 307 the process loops back until the user is finished entering and submitting all of the data and prints. If the user is finished at step 307, the system, device, or node may determine if the user is authenticated at step 308.

If the user is not authenticated at step 308, the process may loop back to step 306 where the user is given an error message and may be required to scan another print or renter characters, numbers, or symbols that they got wrong. Like other security systems, a user may be locked out for a period of time if the user can not gain authentication in a set number of attempts. If the user is authenticated for entry or access at step 308, then access is granted at step 308 and the process ends for the user. The security device and authentication procedure may be used to start a vehicle, or to enter a building, or to access files on a computer system, or to complete a transaction, or to open a safe or vault or the like.

In one aspect, the user may have all of the characters, numbers, and symbols of a pass code and may have the scanned the finger prints and thumb prints authenticating individual ones of the characters, numbers, or symbols stored after creation on a memory drive or a plug-in machine-readable key or memory device wherein after submitting the data by plugging it into a reader for example, the system prompts the user only for the fresh scans to match with the scans just received. In this embodiment, the resource the user is attempting to gain entry or access to may never store the user's finger or thumb prints but only the character string of the pass code. Therefore a token may be created having the data on it wherein the token is decrypted and read before the resource asks for the freshly scanned prints to validate the bio-pass code as being that of the current user.

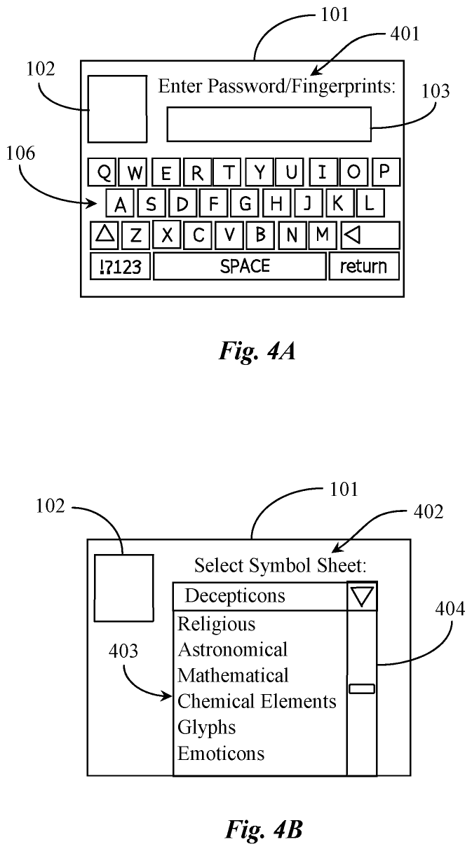

FIG. 4A is a screen shot of the security screen 101 of FIG. 1A prompting a user to enter a bio-pass code using keyboard 106 and fingerprint scanner 102 to unlock the security device 100 of FIG. 1A from a sleep mode. In one embodiment, the security device may be protected from theft by requiring a bio-pass code to be authenticated on the device before the device can be booted and used to access other resources.

In this embodiment, screen 101 may appear when the security device is waking from a sleep mode by moving the device or picking up the device before boot. The screen may prompt the user, prompt 401, to enter the bio-pass code using keyboard features 106 and scanner 102 before gaining access to the fully booted version of the device. The encrypted bio-pass code may appear in entry field 103 with encryption on or off. The user may be required to remember or to have written down the passcode and the correct finger/thumb prints to scan into the device. In this case, the scanner and authentication procedure are active on the device before full capabilities of the device may be accessed by authenticating to the device.

FIG. 4B is a screen shot of security screen 101 of FIG. 1A displaying symbol character sheets as a resource for selecting characters for a bio-pass code. In one embodiment, symbols may be provided to a user for consideration in use of creating passcodes. In this case screen 101 may display a prompt 402 to offer the user an opportunity to select one of several symbol sheets containing selectable symbols for inclusion into the pass code. A drop-down menu 403 is provided with a scroll mechanism 404. The user may select any of the listed symbol sheets to display all of the symbols available to select from.

In one embodiment, a user may toggle between or otherwise navigate back and forth between characters and numbers of keyboard 106 and available symbols. Scanner window 102 may remain displayed in the same location on screen 101 and may automatically scan any fingerprint or thumbprint laid on it. Symbol sheets 403 may include but are not limited to sheets presenting deceptions, religious, astronomical, mathematical, chemical elements, glyphs, and emoticons. In one embodiment, the security device may save the user's password and fingerprint settings into the device's internal memory. In another embodiment, the saved settings may be used to unlock the user's device once the correct password, from the correct symbol sheet and matching fingerprints are entered into the device.

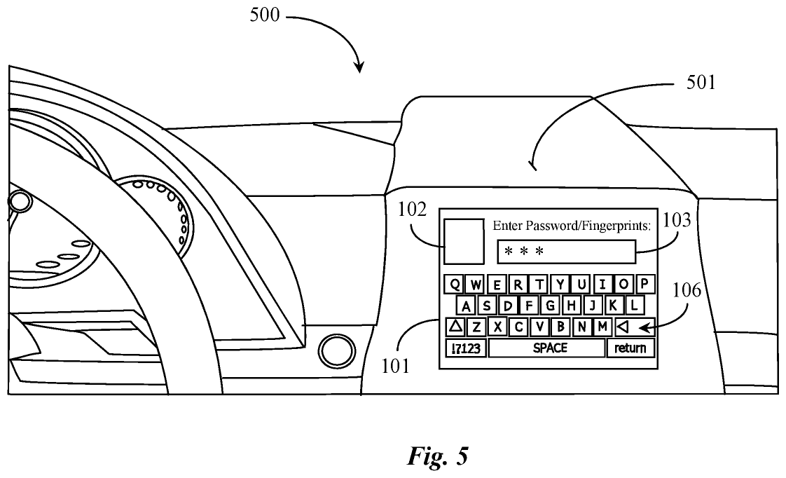

FIG. 5 is a screen shot of security screen 101 of FIG. 1A of the security device of FIG. 1A integrated with a computer system 501 of an automobile 500 according to an embodiment of the present invention. As described further above, the security interface including scan capabilities may be integrated into a system or machine like a vehicle, for example. Automobile 500 is illustrated in partial view depicting a computing system 501 having screen 101 of the fashion of security device 100 integrated therewith.

In this example, a user may open automobile 500 and before start screen 101 appears and prompts the user to enter the bio-pass code characters, numbers, and or symbols into field 103 using keyboard features 106 and then providing fresh scans through scan window 102. In one embodiment, the input features like a keyboard or keypad for example may be physical devices and not displayed devices. However, touch screen devices may be more economical for devices, systems, and machines. Also, in some embodiments, other input means that may differ slightly or moderately from features 106 may be provided or may already exist for use in a system, device or network node provided all of the possible characters may be represented.

In one embodiment, computer system 501 may have a port or a reader that may read a created bio-password stored for use on a plug-in device wherein the computer system prompts the user for the fresh scans after the device is read and authentication ensues when the scans are matched to the stored versions.

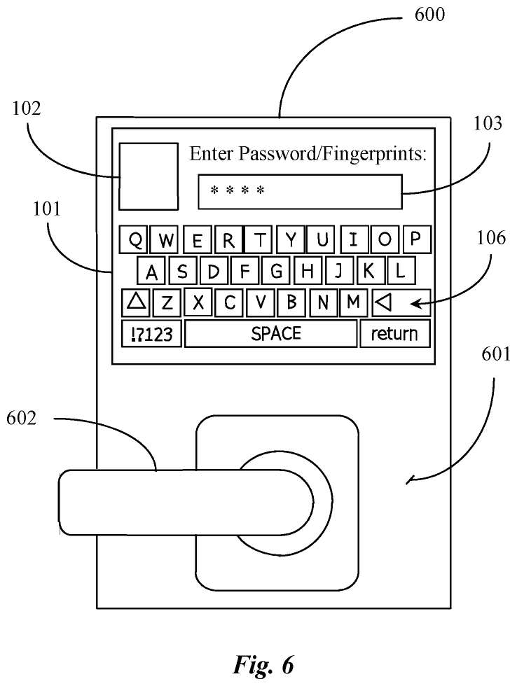

FIG. 6 is a screen shot of security screen 101 of FIG. 1A of security device 100 of FIG. 1A integrated into a computerized door lock system 600 according to an embodiment of the present invention. Door lock system 600 may include a face plate 601 with a security lock 602 locked by default. Door lock system 600 may use screen 101 as a touch screen device containing the elements of security device screen 101 in a state of always on or active so users may gain access by using keyboard features 106 and fingerprint scanner 102 to provide the correct bio-pass code that may unlock the latch and let the user operate the latch to enter the room.

In other embodiments the security device 100 of the present invention may be a stand-alone peripheral unit that may be connected via a standard tether connection (USB, mini USB, micro USB) or by a wireless connection (Bluetooth or Wi-Fi) to an existing computing device. In this embodiment, the accessory unit along with software, may provide secure access to the computing device that it is added to.

It will be apparent with skill in the art that the smart card of the present invention may be provided using some or all the elements described herein. The arrangement of elements and functionality thereof relative to the smart card of the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. A computing device for generating and communicating a linear security code sequence, individual ones or combinations of the generated security code sequence associated with at least one device-generated bio signature from a user operating the device, the device comprising:
a computer housing;
a power source;
a micro controller;
a boot device;
a memory device;
a wireless communications chip or modem;
an electronic display; and
a data entry interface.

2. The computing device of claim 1, wherein the linear security code sequence generated contains one or a combination of alphanumeric characters and or symbols.

3. The computing device of claim 1, wherein the at least one bio signature of a user operating the device includes at least one fingerprint or thumb print or a combination thereof.

4. The computing device of claim 3, wherein the bio signature is generated by a fingerprint scanning application and a scan window appearing in the electronic display, the application executable from device memory by an operating system (OS).

5. The computing device of claim 1, wherein the power source is a rechargeable battery.

6. The computing device of claim 1, wherein the data entry interface is a touch screen feature in the electronic display.

7. The computing device of claim 1, wherein the wireless chip is a Bluetooth chip enabling communications between the computing device and another Bluetooth system, device, or node.

8. The computing device of claim 1, wherein the wireless modem enables the computing device to connect to an Internet network resource.

9. The computing device of claim 4, wherein access to the OS on the computing device requires entry and authentication of a linear security code generated on the device and scan and authentication of the at least one fingerprint and or thumbprint associated to the individual ones or combinations of the linear security code characters.

10. The computing device of claim 3, wherein each generated character of the generated linear security code is associated to a unique fingerprint or thumbprint.

11. The computing device of claim 1, integrated into an automobile computer system.

12. The computing device of claim 1, integrated into a door lock having a default state of being locked.

13. The computing device of claim 3, wherein the fingerprint scan window is supported by hardware adapted to scan images, codes, and fingerprints and or thumbprints.

14. A method for electronic generation of a linear security code, individual ones or combinations of the code characters associated to at least one or a combination of finger and or thumbprints using a computing device, the computing device including a computer housing, a power source, a micro controller, a boot device, a memory device, a wireless communications chip or modem, an electronic display, and a data entry interface comprising the steps:
(a) booting the computing device to a run state;
(b) on the computing device, displaying a bio-pass code data entry field and highlighting a fingerprint scan window in the display;
(c) on the computing device, entering a one or more characters, numbers, or symbols, or a combination thereof via the data entry interface into the bio-pass code data entry field;
(d) on the computing device, scanning in a fingerprint or a thumbprint via the scan window of (b);
(e) on the computing device, associating the finger or thumbprint of (d) to the character, number, or symbol, or combination thereof entered in (c);
(f) repeating steps (c), (d), and (e) until a required or desired number of characters, numbers, or symbols and fingerprints, thumbprints, or a combination thereof are entered.

15. The method of claim 14, wherein the scan window is part of a bio-signature scanning application executable from the memory on the device.

16. The method of claim 14, wherein in (a) a bio-pass code must be entered and authenticated before the device can be booted to a run state.

17. The method of claim 14, wherein in (c) the data entry interface is a physical keyboard or keypad.

18. The method of claim 14, wherein in (c) the data entry interface is a digital keyboard or keypad and is part of the display.

19. The method of claim 14, wherein in (e), the association is made automatically in the background.

20. The method of claim 14, wherein in (f), the bio-pass code is created for the first time or the bio-pass code is being used to authenticate a user to gain access to one of a physical space, a virtual space, or a data resource, or to authenticate the user in a transaction.
